(19) United States
(12) Patent Application Publication
(10) Pub. No.: US 2023/0335721 A1
(43) Pub. Date: Oct. 19, 2023

(54) CATHODE ACTIVE MATERIAL FOR LITHIUM SECONDARY BATTERY, METHOD OF PREPARING THE SAME AND LITHIUM SECONDARY BATTERY INCLUDING THE SAME

(71) Applicant: SK ON CO., LTD., Seoul (KR)

(72) Inventors: Hyun Wook KIM, Daejeon (KR); Gyu Sik KIM, Daejeon (KR)

(21) Appl. No.: 18/188,469

(22) Filed: Mar. 23, 2023

(30) Foreign Application Priority Data
Apr. 13, 2022 (KR) 10-2022-0045837

(51) Int. Cl. H01M 4/36; H01M 10/052; H01M 4/525; H01M 4/505; H01M 4/131; H01M 4/587; H01M 4/133; C01G 53/00

(52) U.S. Cl. CPC H01M 4/366; H01M 10/052; H01M 4/525; H01M 4/505; H01M 4/131; H01M 4/587; H01M 4/133; C01G 53/50; H01M 2004/028

(57) ABSTRACT

A cathode active material for a lithium secondary battery according to an embodiment of the present invention includes a core portion containing a lithium metal oxide, and a shell portion covering at least a portion of a surface of the core portion and including a reduced carbon nanotube oxide. The cathode active material provides enhanced electrical conductivity.

### CROSS-REFERENCE TO RELATED APPLICATION

This application claims priority to Korean Patent Application No. 10-2022-0045837 filed on Apr. 13, 2022 in the Korean Intellectual Property Office (KIPO), the entire disclosure of which is incorporated by reference herein.

### BACKGROUND

### 1. Field of the Invention

The present invention relates to a cathode active material for a lithium secondary battery, a method of preparing the same and a lithium secondary battery including the same. More particularly, the present invention relates to a lithium metal oxide-based cathode active material, a method of preparing the same and a lithium secondary battery including the same.

### 2. Description of the Related Art

A secondary battery which can be charged and discharged repeatedly has been widely employed as a power source of a mobile electronic device such as a camcorder, a mobile phone, a laptop computer, etc., according to developments of information and display technologies. Recently, a battery pack including the secondary battery is being developed and applied as an eco-friendly power source of an electric automobile, a hybrid vehicle, etc.

Examples of the secondary battery includes, e.g., a lithium secondary battery, a nickel-cadmium battery, a nickel-hydrogen battery, etc. The lithium secondary battery is actively developed and applied due to high operational voltage and energy density per unit weight, a high charging rate, a compact dimension, etc.

For example, the lithium secondary battery may include an electrode assembly including a cathode, an anode and a separation layer (separator), and an electrolyte immersing the electrode assembly. The lithium secondary battery may further include an outer case having, e.g., a pouch shape for accommodating the electrode assembly and the electrolyte.

The cathode active material may include a lithium-transition metal oxide. The lithium-transition metal oxide is an electrical insulator, and a carbon-based conductive material having a high electrical conductivity may be used together in a fabrication of the cathode.

However, the carbon-based conductive material has a high specific surface area and a particle aggregation by a van der Waals force may easily occur, resulting in a poor dispersion in a cathode slurry. The poor dispersion of the conductive material may deteriorate a conductivity of the cathode.

### SUMMARY

According to an aspect of the present invention, there is provided a cathode active material for a lithium secondary battery having improved electrical property and operation reliability.

According to an aspect of the present invention, there is provided a method of preparing a cathode active material for a lithium secondary battery having improved electrical property and operation reliability.

According to an aspect of the present invention, there is provided a lithium secondary battery having improved electrical property and operation reliability.

A cathode active material for a lithium secondary battery according to embodiments of the present invention includes a core portion containing a lithium metal oxide, and a shell portion covering at least a portion of a surface of the core portion and containing a reduced carbon nanotube oxide.

In some embodiments, the core portion may include a nitrogen component doped at a surface of the lithium metal oxide.

In some embodiments, a content of the reduced carbon nanotube oxide may be in a range from 0.01 parts by weight to 1 parts by weight based on 100 parts by weight of the lithium metal oxide.

In some embodiments, the reduced carbon nanotube oxide may include a functional group containing oxygen and hydrogen bonded to a carbon nanotube.

In some embodiments, the shell portion may cover 70% or more of a total surface area of the core portion.

In some embodiments, the shell portion may cover 90% or more of a total surface area of the core portion.

In some embodiments, the lithium metal oxide may have a chemical structure represented by Chemical Formula 1:

LiₓNiₐM_{b}O₂ [Chemical Formula 1]

In Chemical Formula 1, M includes at least one element selected from the group consisting of Co, Mn, Ti, Zr, Al, Mg, Ta, W and Cr, 0.8<x<1.5, 0.7≤a≤0.96, and 0.98≤a+b≤1.02.

In some embodiments, the shell portion may have a thickness ranging from 0.1 μm to 2 μm.

A lithium secondary battery includes a cathode including the cathode active material for a secondary battery according to the above-described embodiments, and an anode facing the cathode.

In some embodiments, the cathode may include a cathode current collector and a cathode active material layer formed on the cathode current collector. The cathode active material layer includes the cathode active material for a secondary battery, and the cathode active material layer may not contain a conductive material.

In some embodiments, the cathode may have a volume resistance of 1Ω or less.

In some embodiments, the cathode may have volume resistance of 0.5Ω or more, and less than 0.9Ω.

In a method of preparing a cathode active material for a lithium secondary battery, a nitrogen component is doped at a surface of a lithium metal oxide to form a core portion. The core portion is reacted with a carbon nanotube oxide to form a preliminary cathode active material having a shell portion. The preliminary cathode active material is reduced.

In some embodiments, the nitrogen component may include nitrogen having a positive charge on the surface of the lithium metal oxide.

In some embodiments, a weight ratio of the shell portion relative to the core portion in the preliminary cathode active material may be in a range from 1/10,000 to 1/100.

In some embodiments, the shell portion may be formed by an electrostatic attraction between the nitrogen component doped in the core portion and the carbon nanotube oxide.

In some embodiments, in the reducing the preliminary cathode active material, a hydrogen gas may be supplied to the preliminary cathode active material at a temperature from 700° C. to 1000° C.

A cathode active material for a lithium secondary battery according to exemplary embodiments of the present invention has a core-shell structure. A core portion may include a lithium metal oxide, and a shell portion may include a reduced carbon nanotube oxide. The cathode active material may have a modified surface and improved electrical conductivity.

Additionally, an electrical conductivity of a cathode active material particle may be improved, so that a volume resistance of the cathode may be remarkably reduced even when a conductive material may not be added to a cathode active material layer.

An economic mass production of the cathode active material having improved electrical conductivity may be implemented using a method of preparing a cathode active material for a lithium secondary battery according to exemplary embodiments of the present invention.

### BRIEF DESCRIPTION OF THE DRAWINGS

FIG. 1 is a schematic view illustrating a structure of a cathode active material for a lithium secondary battery in accordance with exemplary embodiments.

FIG. 2 is a process flow diagram for describing a method of preparing a cathode active material for a lithium secondary battery in accordance with exemplary embodiments.

FIGS. 3 and 4 are a schematic plan view and a schematic cross-sectional view, respectively, illustrating a lithium secondary battery in accordance with exemplary embodiments.

### DETAILED DESCRIPTION OF THE EMBODIMENTS

According to embodiments of the present invention, a cathode active material having a core-shell structure is provided. Further, a method of preparing the cathode active material and a lithium secondary battery including the cathode active material are also provided.

Hereinafter, embodiments of the present invention will be described in detail with reference to embodiments and examples, and the accompanying drawings. However, those skilled in the art will appreciate that such embodiments and drawings are provided to further understand the spirit of the present invention and do not limit subject matters to be protected as disclosed in the detailed description and appended claims.

According to embodiments of the present invention, a cathode active material for a lithium secondary battery (hereinafter, that may be abbreviated as a cathode active material) has a core-shell structure including a core portion and a shell portion covering at least a portion of a surface of the core portion.

In exemplary embodiments, the core portion of the cathode active material may include a lithium metal oxide.

In an embodiment, the lithium metal oxide may include a chemical structure or a crystal structure represented by Chemical Formula 1 below.

LiₓNiₐM_{b}O₂ [Chemical Formula 1]

In Chemical Formula 1, M includes at least one element selected from the group consisting of Co, Mn, Ti, Zr, Al, Mg, Ta, W and Cr, and 0.8<x<1.5, 0.7≤a≤0.96 and 0.98≤a+b≤1.02.

Preferably, the lithium metal oxide may include nickel, cobalt and manganese as main components, and thus may provide balanced properties of power, capacity, life-span and stability. More preferably, the lithium metal oxide may include nickel, cobalt, and manganese as main components, and may further include at least one of Ti, Zr, Al, Mg, Ta, W and Cr as a dopant.

As used herein, the term ‘excess’ refers to being included in the largest content or mole fraction among elements excluding lithium and oxygen.

For example, nickel may serve as a metal related to the capacity of the lithium secondary battery. Nickel may be included in an excess amount among elements other than lithium and oxygen, so that the capacity of the secondary battery may be remarkably improved.

As the content of nickel increases, the capacity and power of the lithium secondary battery may be increased. However, when the content of nickel is excessively increased, the life-span may be lowered, and mechanical and electrical stability may be degraded.

For example, if the content of nickel is excessively increased, defects such as ignition and short circuit may not be sufficiently suppressed when being penetrated by an external object. Accordingly, according to exemplary embodiments, chemical and mechanical instability caused by nickel may be compensated by distributing manganese (Mn) throughout a particle of the cathode active material.

For example, manganese (Mn) may serve as a metal related to mechanical and electrical stability of the lithium secondary battery. For example, manganese may suppress or reduce the defects such as ignition and short circuit caused when the cathode is penetrated by the external object and may enhance the life-span of the lithium secondary battery. Further, cobalt (Co) may serve as a metal associated with a conductivity or a resistance of the lithium secondary battery.

If the mole fraction of nickel is less than 0.7, the capacity and power may be excessively reduced. If the mole fraction of nickel exceeds 0.96, the life-span and mechanical stability may be degraded.

In an embodiment, the core portion may further include a nitrogen component doped on a surface of the lithium metal oxide. For example, the surface of the lithium metal oxide may be doped with nitrogen by heat-treating the lithium metal oxide in a gas atmosphere containing the nitrogen component such as ammonia.

The doped nitrogen has a positive charge, and may be bonded to a negative charge of a carbon nanotube oxide, which will be described later, by an electrostatic attraction to form the shell portion. The cathode active material including the core portion and the shell portion may be subjected to a reductive treatment in a hydrogen gas atmosphere, so that the lithium metal oxide coated with a reduced carbon nanotube oxide at the shell portion may be formed.

In exemplary embodiments, the shell portion may include the reduced carbon nanotube oxide.

For example, a carbon nanotube (CNT) may be oxidized to generate a carbon nanotube oxide into which oxygen atoms are introduced, and the reduced carbon nanotube oxide may include a functional group containing oxygen and hydrogen atoms on a surface of the carbon nanotube.

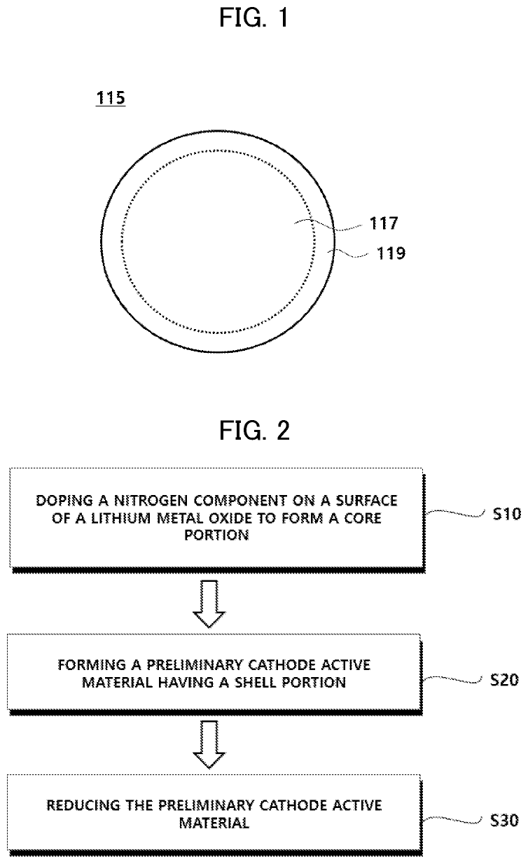

Referring to FIG. 1, the cathode active material 115 includes a shell portion 119 formed on a surface of a core portion 117. The shell portion 119 may at least partially cover the surface of the core portion 117. In an embodiment, the shell portion 119 may be formed as an entire coating continuously formed on the surface of the core portion 117. In an embodiment, the shell portion 119 may be formed in the form of a film including coating particles on the surface of the core portion 117.

For convenience of illustration, the shell portion 119 is shown as the entire coating in FIG. 1, but may be formed as a partial coating covering a portion of the surface of the core portion.

In some embodiments, the shell portion may be discontinuously formed on the surface of the core portion. For example, the coating particles forming the shell portion may be spaced apart from each other and disposed as island shapes on the surface of the core portion.

In some embodiments, the shell portion may cover about 70% or more of a total surface area of the core portion. Within the range of a coverage ratio, a contact between the core portion and an electrolyte or air may be effectively blocked, and an electrical conductivity may be effectively enhanced by the carbon nanotube included in the shell portion. Accordingly, structural stability and electrical conductivity of the secondary battery can be remarkably improved. Preferably, the shell portion may cover about 90% or more of the total surface area of the core portion.

In an embodiment, a thickness of the shell portion may be in a range from 0.1 μm to 2 μm, preferably from 0.5 μm to 1.0 μm. Within the thickness range, sufficient electrical conductivity may be provided while improving structural stability of the cathode active material.

In an embodiment, the reduced carbon nanotube oxide may be included in an amount from 0.01 parts by weight to 1 parts by weight based on 100 parts by weight of the lithium metal oxide. Preferably, the reduced carbon nanotube oxide may be included in an amount from 0.05 parts by weight to 0.5 parts by weight based on 100 parts by weight of the lithium metal oxide. Within this range, improved electrical conductivity and structural stability of the particles of the cathode active material may be effectively achieved.

The carbon nanotube of the reduced carbon nanotube oxide may be a single-walled carbon nanotube (SWNT) or a multi-walled carbon nanotube (MWCNT).

In some embodiments, an average diameter of the carbon nanotubes may be in a range from 1 nm to 30 nm, preferably from 3 nm to 26 nm, and more preferably from 5 nm to 22 nm. Within the above range, the carbon nanotubes may be uniformly dispersed and coated on the surface of the cathode active material to form the shell portion having a uniform thickness. The average diameter may be measured by a TEM or an SEM.

In some embodiments, a BET specific surface area of the carbon nanotubes may be in a range from 100 m²/g to 300 m²/g, preferably from 125 m²/g to 275 m²/g, more preferably from 150 m²/g to 250 m²/g. Within the above range, the carbon nanotubes may be easily dispersed when forming the shell portion, and thus the conductivity of the cathode active material may be improved. The BET specific surface area may be measured using a nitrogen adsorption BET method.

As described above, the shell portion may include the reduced carbon nanotube oxide, and the electrical conductivity may be further improved compared to the case using other carbon components such as a reduced graphene oxide.

FIG. 2 is a process flow diagram for describing a method of preparing a cathode active material for a lithium secondary battery in accordance with exemplary embodiments.

In exemplary embodiments, a lithium metal oxide and a carbon nanotube oxide may be prepared.

The lithium metal oxide may have a chemical structure or crystal structure represented by Chemical Formula 1 as described above.

The carbon nanotube oxide may be generated by oxidizing a carbon nanotube (CNT), and may have a negative charge by introduction of oxygen atoms.

A core part may be formed by doping the surface of the lithium metal oxide with a nitrogen component (e.g., step S10).

In exemplary embodiments, the lithium metal oxide may be introduced into an ammonia gas or a nitrogen gas atmosphere, and heat-treated at a high temperature. Accordingly, the nitrogen component having a positive charge may be included on the surface of the lithium metal oxide.

For example, a temperature of the heat-treatment for forming the doping may be in a range from 400° C. to 700° C., preferably from 500° C. to 650° C. In the above temperature range, a sufficient amount of nitrogen may be economically doped on the surface of the lithium metal oxide.

The core portion may react with the carbon nanotube oxide to form a preliminary cathode active material having a shell portion (e.g., step S20).

In exemplary embodiments, the core portion containing nitrogen that has the positive charge may be input in a solvent together with the carbon nanotube oxide having the negative charge to react with each other, so that the shell portion may be formed on the core portion by an electrostatic attraction. Accordingly, the preliminary cathode active material in which the carbon nanotube oxide may be evenly coated on the surface of the nitrogen-doped lithium metal oxide may be formed.

The preparation of the preliminary cathode active material may be performed at room temperature. The solvent may include, e.g., dimethylformamide (DMF), dimethyl sulfoxide (DMSO), N-methyl-2-pyrrolidone (NMP), etc.

In an embodiment, a weight ratio of the shell portion relative to the core portion in the preliminary cathode active material may be in a range from 1/10,000 to 1/100. Preferably, the weight ration may be in a range from 5/10,000 to 5/1,000. Within this range, improved electrical conductivity may be provided, and structural stability of particles of the cathode active material particles may also be enhanced.

The preliminary cathode active material may be reduced to form a cathode active material including the lithium metal oxide in the core portion and a reduced carbon nanotube oxide in the shell portion (e.g., step S30).

In an embodiment, the reduction of the preliminary cathode active material may be performed by supplying a hydrogen gas to the preliminary cathode active material at a temperature ranging from 700° C. to 1000° C. Preferably, the reduction of the preliminary cathode active material may be performed in a hydrogen gas atmosphere at a temperature ranging from 700° C. to 900° C.

The carbon nanotube oxide included in the shell portion may be converted into the reduced nanotube oxide through the hydrogen reduction at high temperature. Thus, the surface of the cathode active material may be efficiently modified, and a mass-production of the cathode active material having improved electrical conductivity can be implemented.

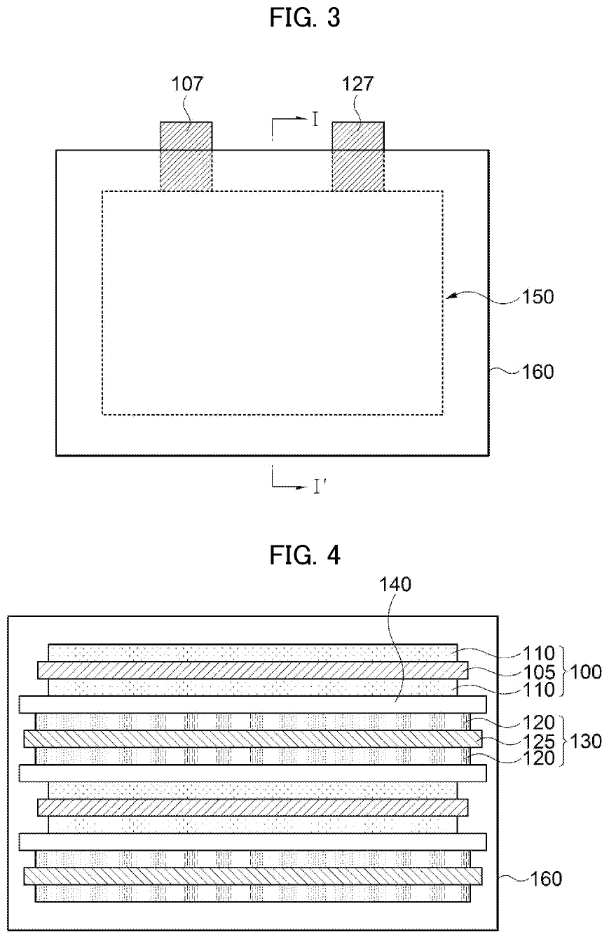

FIGS. 3 and 4 are a schematic plan view and a schematic cross-sectional view, respectively, illustrating a lithium secondary battery in accordance with exemplary embodiments.

Referring to FIGS. 3 and 4, the lithium secondary battery may include a cathode 100 including the above-described cathode active material and an anode 130 facing the cathode 100.

The cathode 100 may include the cathode active material having the core-shell structure that includes the lithium metal oxide in the core portion and the reduced carbon nanotube oxide in the shell portion as described above. The cathode 100 may include a cathode active material layer 110 formed by coating the cathode active material having the core-shell structure on the cathode current collector 105.

For example, a cathode slurry may be prepared by mixing and stirring the above-described core-shell structured cathode active material with a binder and a dispersive agent in a solvent. The core-shell structured cathode active material may provide sufficient electrical conductivity, and thus the cathode slurry may not include a conductive material.

Thus, the cathode active material layer 110 may not include the conductive material, and degradation of the electrical conductivity of the cathode due to a poor dispersion of the conductive material in the slurry may be prevented. The cathode slurry may be coated on the cathode current collector 105, and then dried and pressed to form the cathode 100.

In some embodiments, the cathode 100 may have a volume resistance of 1Ω or less, preferably 0.5Ω or more and less than 0.9Ω. As described above, the cathode active material may provide sufficient electrical conductivity even when the conductive material may not be used.

The cathode current collector 105 may include stainless-steel, nickel, aluminum, titanium, copper or an alloy thereof. Preferably, aluminum or an alloy thereof may be used.

The binder may include an organic based binder such as a polyvinylidene fluoride-hexafluoropropylene copolymer (PVDF-co-HFP), polyvinylidene fluoride (PVDF), polyacrylonitrile, polymethylmethacrylate, etc., or an aqueous based binder such as styrene-butadiene rubber (SBR) that may be used with a thickener such as carboxymethyl cellulose (CMC).

For example, a PVDF-based binder may be used as a cathode binder. In this case, an amount of the binder for forming the cathode active material layer 110 may be reduced, and an amount of the cathode active material may be relatively increased. Thus, capacity and power of the lithium secondary battery may be further improved.

The anode 130 may include an anode current collector 125 and an anode active material layer 120 formed by coating an anode active material on a surface of the anode current collector 125.

The anode active material may include a material commonly used in the related art which may be capable of adsorbing and ejecting lithium ions. For example, a carbon-based material such as a crystalline carbon, an amorphous carbon, a carbon complex or a carbon fiber, a lithium alloy, a silicon-based compound, tin, etc., may be used.

The amorphous carbon may include a hard carbon, coke, a mesocarbon microbead (MCMB), a mesophase pitch-based carbon fiber (MPCF), etc.

The crystalline carbon may include a graphite-based material such as natural graphite, graphitized coke, graphitized MCMB, graphitized MPCF, etc.

The lithium alloy may further include aluminum, zinc, bismuth, cadmium, antimony, silicon, lead, tin, gallium, indium, etc.

The anode current collector 125 may include, e.g., gold, stainless steel, nickel, aluminum, titanium, copper, or an alloy thereof, and preferably may include copper or a copper alloy.

In some embodiments, a slurry may be prepared by mixing and stirring the anode active material with an anode binder, a conductive material and/or a dispersive agent in a solvent. The anode slurry may be coated on the anode current collector, and then dried and pressed to form the anode 130.

The binder substantially the same as or similar to those used for the cathode active material layer 110 may be used in the anode 130.

For example, the conductive material of the anode 130 may include a carbon-based material such as graphite, carbon black, graphene, carbon nanotube, etc., and/or a metal-based material such as tin, tin oxide, titanium oxide, a perovskite material such as LaSrCoO₃ or LaSrMnO₃, etc.

In some embodiments, the binder for forming the anode 130 may include an aqueous binder such as styrene-butadiene rubber (SBR) for a compatibility with the carbon-based active material, and carboxymethyl cellulose (CMC) may also be used as a thickener.

The separation layer 140 may be interposed between the cathode 100 and the anode 130. The separation layer 140 may include a porous polymer film prepared from, e.g., a polyolefin-based polymer such as an ethylene homopolymer, a propylene homopolymer, an ethylene/butene copolymer, an ethylene/hexene copolymer, an ethylene/methacrylate copolymer, or the like. The separation layer 140 may also include a non-woven fabric formed from a glass fiber with a high melting point, a polyethylene terephthalate fiber, or the like.

In exemplary embodiments, an electrode cell may be defined by the cathode 100, the anode 130 and the separation layer 140, and a plurality of the electrode cells may be stacked to form the electrode assembly 150 that may have e.g., a jelly roll shape. For example, the electrode assembly 150 may be formed by winding, laminating or folding of the separation layer 140.

The electrode assembly 150 may be accommodated together with the electrolyte in an outer case 160 to define the lithium secondary battery. In exemplary embodiments, a non-aqueous electrolyte may be used as the electrolyte.

The non-aqueous electrolyte may include a lithium salt and an organic solvent. The lithium salt may be represented by Li⁺X⁻, and an anion of the lithium salt X⁻ may include, e.g., F⁻, Cl⁻, Br⁻, I⁻, NO₃⁻, N(CN)₂⁻, BF₄⁻, ClO₄⁻, PF₆, (CF₃)₂PF₄⁻, (CF₃)₃PF₃⁻, (CF₃)₄PF₂⁻, (CF₃)₅PF⁻, (CF₃)₆P⁻, CF₃SO₂⁻, CF₃CF₂SO₃⁻, (CF₂₃SO₂)₂N⁻, (FSO₂)₂N⁻, CF₃CF₂(CF₃)₂CO⁻, (CF₃SO₂)₂CH⁻, (SF₅)₃C⁻, (CF₂SO₂)₃C⁻, CF₃(CF₂)₇SO₃⁻, CF₃CO₂⁻, CH₃CO₂⁻, SCN⁻, (CF₃CF₂SO₂)₂N⁻, etc.

The organic solvent may include, e.g., propylene carbonate (PC), ethylene carbonate (EC), diethyl carbonate (DEC), dimethyl carbonate (DMC), ethylmethyl carbonate (EMC), methylpropyl carbonate, dipropyl carbonate, dimethyl sulfoxide, acetonitrile, dimethoxy ethane, diethoxy ethane, vinylene carbonate, sulfolane, gamma-butyrolactone, propylene sulfite, tetrahydrofuran, etc. These may be used alone or in a combination of two or more therefrom.

As illustrated in FIG. 4, electrode tabs (a cathode tab and an anode tab) may protrude from the cathode current collector 105 and the anode current collector 125 included in each electrode cell to one side of the outer case 160. The electrode tabs may be welded together with the one side of the outer case 160 to be connected to an electrode lead (a cathode lead 107 and an anode lead 127) that may be extended or exposed to an outside of the outer case 160.

The lithium secondary battery may be manufactured in, e.g., a cylindrical shape using a can, a square shape, a pouch shape or a coin shape.

Hereinafter, preferred embodiments are proposed to more concretely describe the present invention. However, the following examples are only given for illustrating the present invention and those skilled in the related art will obviously understand that various alterations and modifications are possible within the scope and spirit of the present invention. Such alterations and modifications are duly included in the appended claims.

### Example

(1) Preparation of Cathode Active Material

A cathode active material LiNi_{0.8}Co_{0.1}Mn_{0.1}O₂ was placed in a crucible and heat-treated using an electric furnace at 600° C. for 5 hours while flowing an ammonia gas at 400 ppm. Accordingly, positively charged nitrogen was doped on a surface of the heat-treated cathode active material.

The nitrogen-doped cathode active material and a carbon nanotube oxide having a negative charge were dissolved in N-methyl-2-pyrrolidone with a weight ratio of 100:0.1 to form a mixed solution, and the mixed solution was stirred at room temperature for 2 hours at 400 rpm and reacted.

Thereafter, the mixed solution was filtered to extract N-methyl-2-pyrrolidone, thereby obtaining the nitrogen-doped cathode active material coated with the carbon nanotube oxide on a surface thereof. The carbon nanotube oxide was evenly coated on the surface of the cathode active material by an electrostatic attraction between the positive charge of the nitrogen doped on the surface of the cathode active material and the negative charge of the carbon nanotube oxide.

The cathode active material was place in a crucible and heat-treated using an electric furnace at 800° C. for 8 hours while flowing a hydrogen gas at 1,000 ppm. Accordingly, the carbon nanotube oxide coated on the surface of the nitrogen-doped cathode active material was reduced to be converted into a reduced carbon nanotube oxide, and the reduced carbon nanotube oxide was coated on the surface of LiNi_{0.8}Co_{0.1}Mn_{0.1}O₂.

(2) Fabrication of Lithium Secondary Battery

A secondary battery was manufactured using the cathode active material prepared in the (1) above. Specifically, a cathode slurry was prepared by mixing the cathode active material and PVDF as a binder in a mass ratio of 98:2, and the cathode slurry was coated on an aluminum current collector, and then dried and pressed to prepare a cathode. After the pressing, the target electrode density of the cathode was adjusted to 3.0 g/cc.

A lithium metal was used as an anode.

The cathode and the anodes prepared as described above were notched and laminated in a circular shape having diameters of Φ14 and Φ16, respectively, and a separator (polyethylene, thickness 13 μm) notched with Φ19 was interposed between the cathode and the anode to form an electrode cell. The electrode cell was placed in a coin cell exterior material having a diameter of 20 mm and a height of 1.6 mm, and an electrolyte was injected. The assembly was aged for 12 hours or more so that the electrolyte could be impregnated into the electrode to prepare a lithium secondary battery.

A 1M LiPF₆ solution using a mixed solvent of EC/EMC (30/70; volume ratio) was used as the electrolyte.

### Comparative Example 1

The cathode active material LiNi_{0.8}Co_{0.1}Mn_{0.1}O₂ and PVDF as a binder were mixed in a mass ratio of 98:2, coated on an aluminum current collector, and then dried and pressed to prepare a cathode. Thereafter, the same processes as those in Example were performed to obtain a lithium secondary battery.

### Comparative Example 2

The cathode active material LiNi_{0.8}Co_{0.1}Mn_{0.1}O₂, a conductive material (carbon black), and the binder were mixed in a mass ratio of 97:1:2, coated on the aluminum current collector, and then dried and pressed prepare a cathode. Thereafter, the same processes as those in Example were performed to obtain a lithium secondary battery.

### Comparative Example 3

A lithium secondary battery was fabricated by the same method as that in Example 1, except that the nitrogen-doped cathode active material and a graphene oxide having a negative charge were dissolved in N-methyl-2-pyrrolidone in a weight ratio of 100:0.1 to form a mixed solution, and the cathode active material LiNi_{0.8}Co_{0.1}Mn_{0.1}O₂ coated with a reduced graphene oxide on a surface thereof was formed when preparing the cathode active material.

### Comparative Example 4

A lithium secondary battery was fabricated by the same method as that in Example 1, except that the cathode active material LiNi_{0.8}Co_{0.1}Mn_{0.1}O₂ and a carbon nanotube were mixed in a weight ratio of 100:0.1, and a surface of the cathode active material was dry-coated with the carbon nanotube using Nobilta NOB-MINI (manufactured by Hosokawa) when preparing the cathode active material.

### Experimental Example: Electrode Volume Resistance Calculation

Volume resistances (bulk resistance) of the cathodes in the lithium secondary batteries according to the above-described Example and Comparative Examples were measured by a four-probe method using a low resistivity meter (manufactured by Mitsubishi Chemical Analytic Co., Ltd., product name: Loresta GP, model number: MCP-T610) under conditions of 23° C., 15% or less of a relative humidity and a load of 9.8 MPa.

The results are shown in Table 1 to 3 below.

TABLE 1

| No. | Volume Resistance (Ω) |
|---|---|
| Example 1 | 0.7 |
| Comparative Example 1 | 12,000 |
| Comparative Example 2 | 1.4 |
| Comparative Example 3 | 0.9 |
| Comparative Example 4 | 1.0 |

Referring to Table 1, in Comparative Example 1 where the conductive material was not added during the preparation of the cathode active material layer, the volume resistance of the cathode explicitly increased. In Comparative Example 2 where the conductive material (carbon black) was added in the cathode active material layer, the volume resistance was reduced.

In Example 1 where the conductive material was not included in the cathode, the volume resistance was reduced compared to that from Comparative Example 2.

In Example 1, the volume resistance was reduced compared to that of Comparative Example 3 including the reduced graphene oxide (rGO) in the shell portion of the cathode active material.

Further, in Example 1, the volume resistance was reduced compared to that of Comparative Example 4 where the carbon nanotubes were dry-coated at the shell portion of the cathode active material.

From the above results, it can be acknowledged that the resistance was further reduced by introducing the coating by the electrostatic attraction between the core portion and the shell portion.

What is claimed is:

1. A cathode active material for a lithium secondary battery, comprising:
a core portion containing a lithium metal oxide; and
a shell portion covering at least a portion of a surface of the core portion and containing a reduced carbon nanotube oxide.

2. The cathode active material for a lithium secondary battery according to claim 1, wherein the core portion comprises a nitrogen component doped at a surface of the lithium metal oxide.

3. The cathode active material for a lithium secondary battery of claim 1, wherein a content of the reduced carbon nanotube oxide is in a range from 0.01 parts by weight to 1 parts by weight based on 100 parts by weight of the lithium metal oxide.

4. The cathode active material for a lithium secondary battery according to claim 1, wherein the reduced carbon nanotube oxide includes a functional group containing oxygen and hydrogen bonded to a carbon nanotube.

5. The cathode active material for a lithium secondary battery according to claim 1, wherein the shell portion covers 70% or more of a total surface area of the core portion.

6. The cathode active material for a lithium secondary battery according to claim 1, wherein the shell portion covers 90% or more of a total surface area of the core portion.

7. The cathode active material for a lithium secondary battery according to claim 1, wherein the lithium metal oxide has a chemical structure represented by Chemical Formula 1:
LiₓNiₐM_{b}O₂ [Chemical Formula 1]
wherein, in Chemical Formula 1, M includes at least one element selected from the group consisting of Co, Mn, Ti, Zr, Al, Mg, Ta, W and Cr, 0.8<x<1.5, 0.7≤a≤0.96, and

0.98≤a+b≤1.02.

8. The cathode active material for a lithium secondary battery according to claim 1, wherein the shell portion has a thickness ranging from 0.1 μm to 2 μm.

9. A lithium secondary battery, comprising:
a cathode comprising the cathode active material for a secondary battery according to claim 1; and
an anode facing the cathode.

10. The lithium secondary battery according to claim 9, wherein the cathode comprises a cathode current collector and a cathode active material layer formed on the cathode current collector, the cathode active material layer comprising the cathode active material for a secondary battery, and
the cathode active material layer does not contain a conductive material.

11. The lithium secondary battery according to claim 9, wherein the cathode has a volume resistance of 1Ω or less.

12. The lithium secondary battery according to claim 9, wherein the cathode has a volume resistance of 0.5Ω or more, and less than 0.9Ω.

13. A method of preparing a cathode active material for a lithium secondary battery, comprising:
doping a nitrogen component at a surface of a lithium metal oxide to form a core portion;
reacting the core portion with a carbon nanotube oxide to form a preliminary cathode active material having a shell portion; and
reducing the preliminary cathode active material.

14. The method of claim 13, wherein the nitrogen component includes nitrogen having a positive charge on the surface of the lithium metal oxide.

15. The method of claim 13, wherein a weight ratio of the shell portion relative to the core portion in the preliminary cathode active material is in a range from 1/10,000 to 1/100.

16. The method of claim 13, wherein the shell portion is formed by an electrostatic attraction between the nitrogen component doped in the core portion and the carbon nanotube oxide.

17. The method of claim 13, wherein the reducing the preliminary cathode active material comprises supplying a hydrogen gas to the preliminary cathode active material at a temperature from 700° C. to 1000° C.
